(19) United States
(12) Patent Application Publication
(10) Pub. No.: US 2007/0198846 A1
(43) Pub. Date: Aug. 23, 2007

(54) PASSWORD INPUT DEVICE, PASSWORD INPUT METHOD, RECORDING MEDIUM, AND ELECTRONIC APPARATUS

(75) Inventor: Masakazu Watari, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/419,774

(22) Filed: May 23, 2006

(30) Foreign Application Priority Data
Feb. 20, 2006 (JP) 2006-042818

(51) Int. Cl. H04K 1/00

(52) U.S. Cl. 713/184

(57) ABSTRACT

The present invention relates to password input and contributes to facilitation and acceleration of the input. The present invention achieves above objects by displaying candidate symbols of a password randomly at a plurality of display positions of a displaying unit constituted by a sub-display, etc. to select the candidate symbols with select buttons of an input unit corresponding to the display positions to input the password. The candidate symbols of the password include characters, graphics, etc.

### CROSS-REFERENCE TO RELATED APPLICATIONS

This application is based upon and claims the benefit of priority from the prior Japanese Patent Application No. 2006-42818, filed on Feb. 20, 2006, the entire contents of which are incorporated herein by reference.

### BACKGROUND OF THE INVENTION

1. Field of the Invention

The present invention relates generally to input of a password used for person identification (authentication), and, more particularly, to a password input device, password input method, recording medium, and electronic apparatus, using a simple input operation.

2. Description of the Related Art

When using various electronic apparatuses such as a personal computer, databases, information services, etc., a password such as an identical number is frequently used to authenticate a particular user, etc. This password is input by operating keys assigned with characters and symbols representing the password.

With regard such password input, Japanese Patent Application Laid-Open Publication No. 2005-18569 discloses selecting those corresponding to a password character string from a plurality of character string data to prevent password information from being found from the operation when inputting a password (paragraph No. 0046, FIG. 6, etc.); Japanese Patent Application Laid-Open Publication No. 2005-78251 discloses inputting a password by moving a focus in a predetermined cycle along an input candidate character string or displaying input candidate characters successively in the predetermined cycle to select the focused or displayed characters (paragraph No. 0020, FIGS. 2A to 2F, paragraph Nos. 0031, 0032, FIG. 4, etc.); Japanese Patent Application Laid-Open Publication No. 2005-174023 discloses inputting a password by displaying a character string on a surface of a rotating drum on a screen to select characters that appear as the drum rotates (paragraph Nos. 0019, 0020, FIG. 3, etc.).

By the way, if candidate characters of a password are displayed (Japanese Patent Application Laid-Open Publication No. 2005-18569) or if the candidate characters are serially displayed (Japanese Patent Application Laid-Open Publication Nos. 2005-78251 and 2005-174023), since a user must respond to the display and it takes time to input a password, the password may be recognized by other persons from the operation. As the number of characters of a password is increased, it may take more time to input the password

If keys corresponding to candidate characters of a password are required for inputting the password, the number of the keys must correspond to the number of the characters constituting the password and the password may be stolen by other persons from the operation.

Japanese Patent Application Laid-Open Publication Nos. 2005-18569, 2005-78251, and 2005-174023 do not disclose or indicate such problems and do not disclose means for solving the problems or do not include a concept thereof.

### SUMMARY OF THE INVENTION

An object of the present invention relates to the password input and is to contribute to facilitation and acceleration of the input.

Another object of the present invention relates to the password input and is to reduce necessary input keys to contribute to accelerating the password input.

The present invention achieves the above objects by displaying candidate symbols of a password randomly at a plurality of display positions to select the candidate symbols with select buttons of an input unit corresponding to the display positions to input the password. The candidate symbols include characters, graphics, etc.

To achieve the above objects, a first aspect of the present invention is a password input device including a displaying unit that includes a plurality of display positions displaying candidate symbols of a password, a processing unit that displays the candidate symbols at the display positions, an input unit that allows the candidate symbols to be selected with select buttons corresponding to the display positions to input the password.

In such a configuration, a plurality of the display positions for displaying the candidate symbols of the password is set at the displaying unit, and the select buttons of the selecting unit are set correspondingly to each display position of the displaying unit. That is, if a plurality of display positions exists, a symbol string constituted by the candidate characters of the number of the display positions is randomly displayed at certain timing. By operating the select buttons corresponding to the display positions of the candidate symbols corresponding to the password to select the candidate symbols, the password can be input and the above objects are achieved.

To achieve the above objects, preferably, the password input device includes a random-number generating unit that generates random numbers, and a database that stores the candidate symbols of the password, and the processing unit acquires the candidate symbols from the database and displays the candidate symbols at the display positions of the displaying unit, using the random numbers acquired from the random-number generating unit.

In such a configuration, the candidate symbols are randomly displayed at the display positions; if a plurality of display positions exists, the symbol string may be displayed correspondingly to the number thereof; and the password can be input by selecting the candidate symbols with the select button corresponding to the candidate symbols of the password.

To achieve the above objects, in the password input device, the displaying unit may be constituted by a portion of a main display or a sub-display installed on an electronic apparatus. In the password input device, the displaying unit may be constituted by images on a display screen. In the password input device, the select buttons may be constituted by images on a display screen. In the password input device, the candidate symbols may include characters or graphics.

To achieve the above objects, a second aspect of the present invention is a password input method including a process of generating candidate symbols of a password, a process of displaying the generated candidate symbols at a plurality of display positions, and a process of allowing the candidate symbols to be selected with select buttons corresponding to the display positions to input the password. The above objects are also achieved according to such a configuration.

To achieve the above objects, the password input method may comprise the processes of generating random numbers and using the random numbers to acquire the candidate symbols of the password stored in a database. In the password input method, the display positions may be constituted by images on a display screen. In the password input method, the select buttons may be constituted by a keyboard or constituted by images on a display screen.

To achieve the above objects, a third aspect of the present invention is a computer readable recording medium having a password input program executable by a computer embodied therein, the password input program including a step of generating candidate symbols of the password, a step of displaying the generated candidate symbols at a plurality of display positions, and a step of selecting the candidate symbols with select buttons corresponding to the display positions to input the password. The above objects are also achieved according to such a configuration.

To achieve the above objects, in the computer readable recording medium, the password input program may comprise the steps of generating random numbers and using the random numbers to acquire the candidate symbols of the password stored in a database. The password input program may comprise the step of generating the display positions on images on a display screen. The password input program may comprise the step of taking in the candidate symbol at the display position by selecting the select button. The password input program may comprise the step of generating the select buttons on images on a display screen.

To achieve the above objects, a fourth aspect of the present invention is an electronic apparatus accepting password input including a displaying unit that includes a plurality of display positions displaying candidate symbols of a password, a processing unit that displays the candidate symbols at the display positions, an input unit that allows the candidate symbols to be selected with select buttons corresponding to the display positions to input the password. The above objects are also achieved in the electronic apparatus according to such a configuration.

To achieve the above objects, The electronic apparatus may comprise a random-number generating unit that generates random numbers; and a database that stores the candidate symbols of the password, and the processing unit acquires the candidate symbols from the database and displays the candidate symbols at the display positions of the displaying unit, using the random numbers acquired from the random-number generating unit. In the electronic apparatus, the displaying unit may be constituted by a portion of a main display or a sub-display. In the electronic apparatus, the displaying unit may be constituted by images on a display screen. In the electronic apparatus, the select buttons may be constituted by images on a display screen.

The features and advantages of the present invention are listed as follows.

(1) A password can be input by a simple operation to accelerate the password input.

(2) Input keys or key operations necessary for the password input can be reduced to input a password quickly.

(3) The security of passwords and the input thereof can be enhanced.

Other objects, features, and advantages of the present invention will become more apparent with reference to the accompanying drawings and embodiments.

### BRIEF DESCRIPTION OF THE DRAWINGS

FIG. 1 is a block diagram of one configuration example of a password input/authentication system;

FIG. 2 shows one configuration example of a displaying unit and an input unit;

FIGS. 3A and 3B show examples of candidate symbols of a password;

FIG. 4 is a flowchart of a process procedure for password input and authentication;

FIG. 5 is a flowchart of an example of a process procedure for input candidates of a password;

FIG. 6 is a flowchart of an example of a process procedure for monitoring select buttons;

FIGS. 7A, 7B, 7C, 7D, 7E, 7F, 7G, 7H, and 7I show the display of the candidate symbols and the selection of the select buttons;

FIGS. 8A and 8B show the display of the candidate symbols and the selection of the select buttons;

FIG. 9 shows the operation of the select buttons;

FIG. 10 is a flowchart of another example of a process procedure for monitoring the select buttons;

FIG. 11 is a flowchart of another example of a process procedure for monitoring the select buttons;

FIG. 12 shows an image display device that is an example of the displaying unit;

FIG. 13 shows a portable terminal device using the password input/authentication system;

FIG. 14 shows a portable terminal device using the password input/authentication system;

FIG. 15 shows a PDA using the password input/authentication system;

FIG. 16 shows a PDA using the password input/authentication system; and

FIG. 17 shows a PC using the password input/authentication system.

### DETAILED DESCRIPTION OF THE PREFERRED EMBODIMENTS

### First Embodiment

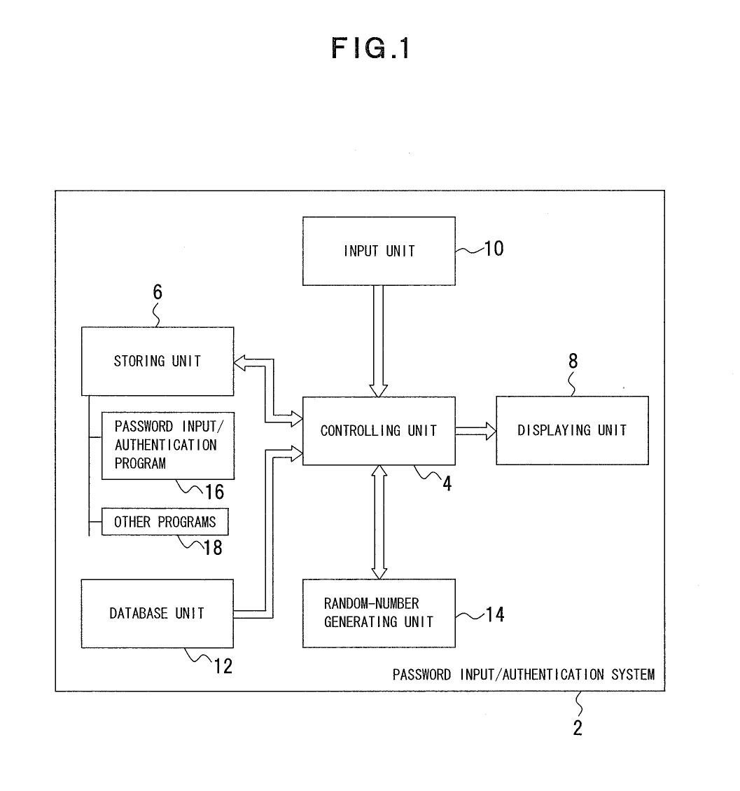

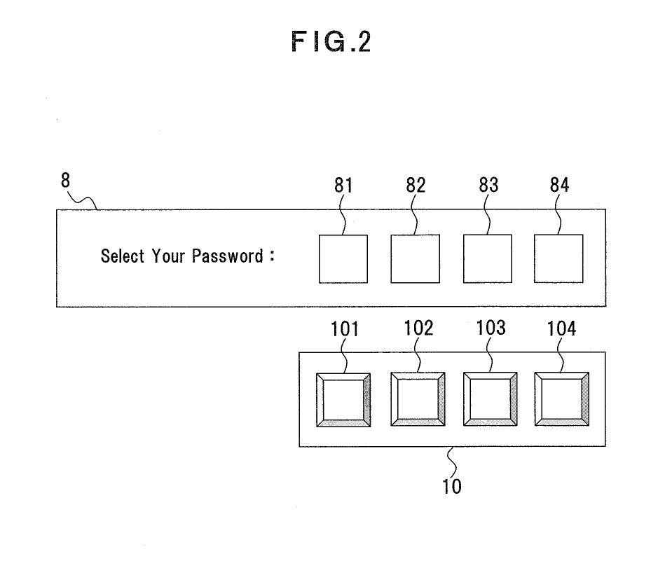

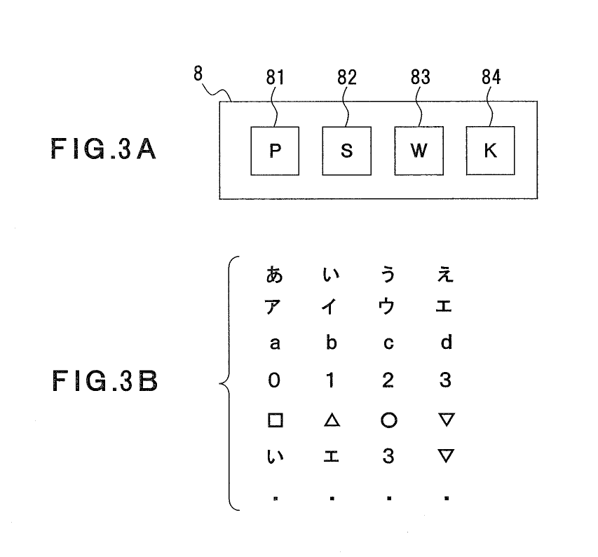

A first embodiment of the present invention will be described with reference to FIGS. 1, 2, 3A, and 3B. FIG. 1 is a block diagram of one configuration example of a password input/authentication system; FIG. 2 shows one configuration example of a displaying unit and an input unit; and FIGS. 3A and 3B show examples of candidate symbols of a password.

This password input/authentication system 2 is a computer system and is used to input a password and to authenticate the password for various electronic apparatuses such as a personal computer (PC). The password input/authentication system 2 includes a controlling unit 4, a storing unit 6, a displaying unit 8, an input unit 10, a database unit 12, a random-number generating unit 14, etc.

The controlling unit 4 is a processing unit that performs the password input and authentication process, is constituted by, for example, a CPU (Central Processing Unit), executes a password input/authentication program 16, etc. of the storing unit 6, and performs processes such as controlling the read-out of data from the displaying unit 8, the input unit 10, the database unit 12 and the random-number generating unit 14, displaying password data on the displaying unit 8 based on random numbers, controlling the password input from the input unit 10, and determining whether or not the input password is identical to the registered password, etc.

The storing unit 6 is constituted by a nonvolatile memory, a hard disk device, etc. as a recording medium and stores the password input/authentication program 16 and other programs 18.

The displaying unit 8 is constituted by a sub-display, etc. of an electronic apparatus such as a personal computer and sets a plurality digit of display positions for displaying candidate symbols (FIGS. 3A and 3B) such as characters and symbols constituting a password. The input unit 10 includes a plurality of select buttons corresponding to the display positions of the displaying unit 8 and detects the operated position of the select buttons. As shown in FIG. 2, for example, the displaying unit 8 and input unit 10 are disposed adjacently to correlate the display with the input; in the displaying unit 8, for example, four-digit display positions 81, 82, 83, 84 are set as a plurality of the display positions; and in the input unit 10, for example, select buttons 101, 102, 103, 104 are disposed as a plurality of the select buttons corresponding to the display positions 81 to 84. The select buttons 101, 102, 103, 104 may be dedicated keys disposed in the input unit 10 or the input unit 10 may be constituted by a keyboard including symbol keys, etc. to assign arbitrary keys such as the symbol keys on the keyboard.

The database unit 12 is constituted by a nonvolatile memory, ROM (Read-Only Memory), etc. and stores a password established in advance and password data used for the password. The password data are one or more candidate symbols such as alphabetical letters and numeric characters as well as graphics and colors. In this case, the candidate symbols include characters and graphics as well as coloring, etc.

The random-number generating unit 14 is constituted by a ROM, etc. and uses a technique of generating pseudo random numbers to generate pseudo random numbers used for controlling the candidate symbols and the display positions 81, 82, 83, 84 of a password.

As shown in FIG. 3A, the candidate symbols used for a password are displayed on the display positions 81 to 84 of the displaying unit 8 to form a symbol string and, as shown in FIG. 3B, the candidate symbols may be any or combination of characters, such as hiragana, alphabet letters, numeric characters, symbols, and katakana, and graphics, such as a circle, a triangle, etc., or may be any forms as long as the symbols can be displayed and recognized at the display positions 81 to 84.

In such a configuration, when the password input/authentication program 16 is executed, the random numbers are acquired from the random-number generating unit 14 and the candidate symbols are read as the password data from the database unit 12 to determine the display positions 81, 82, 83, 84 of the candidate symbols with the use of the random numbers. In this case, the read candidate symbols constitute a symbol string and the digit number of symbols corresponds to the display positions 81, 82, 83, 84. That is, the display positions 81 to 84 are randomly determined for these candidate symbols by the random numbers. The displayed symbol string includes at least one or more candidate symbols identical to the registered password and the same candidate symbols may be displayed at two display positions, for example, the display positions 81, 82.

When a user operates any select buttons 101, 102, 103, 104 corresponding to the positions of the candidate symbols displayed at the display positions 81 to 84, the candidate symbol at that position is selected and input, and if the password is composed of four-digit candidate symbols, four candidate symbols are selected by four input operations to complete the password input. The authentication is performed to determine whether or not the input password is identical to the registered password; the password input is completed if the passwords are identical; and the password must be input again if not identical.

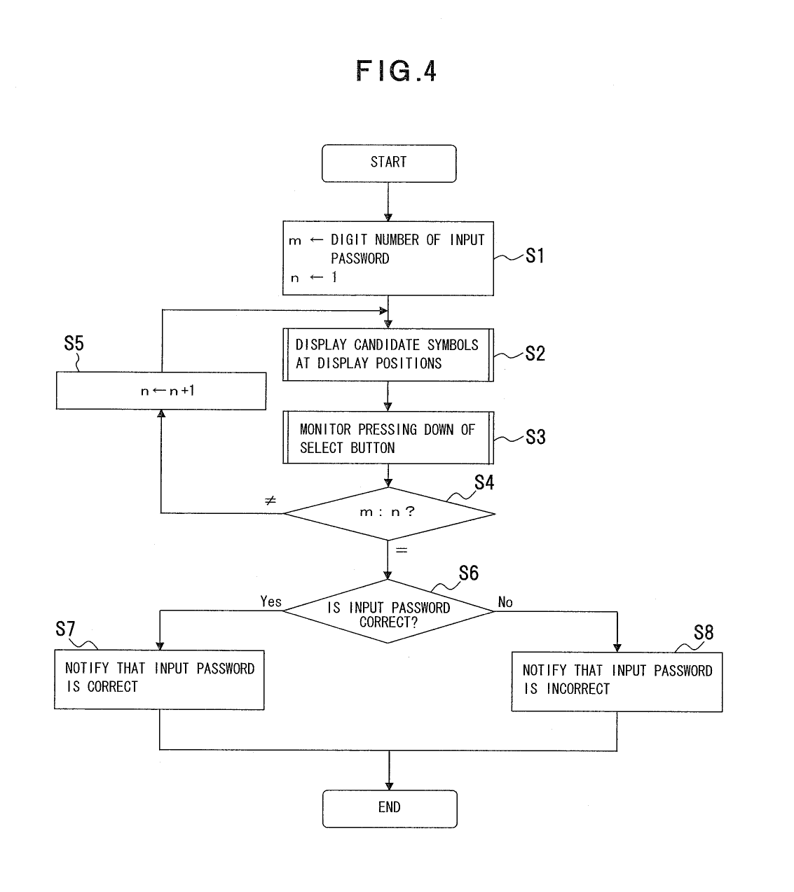

A process procedure of the password input and authentication will be described with reference to FIG. 4. FIG. 4 is a flowchart of a process procedure for the password input and authentication.

This process includes processes of determining the candidate symbols and the display positions of the password, displaying the password, and authenticating the input password.

The password input/authentication program 16 is executed and the display positions are determined for the candidate symbols, which are password data (step S1). At step S1, m is a digit number of the input password, and when the password is four-digit, m=4. n is a digit position in digit number m and n=1, 2, 3, . . . .

When the nth digit of the password is specified, the nth-digit candidate symbol are picked up from the password data along with candidate symbols of other digits, and these candidate symbols are displayed as input candidate symbols at the display positions 81 to 84 of the displaying unit 8 (step S2). The pressing down of the select buttons 101 to 104 is monitored correspondingly to the display (step S3); if any one of select button 101 to 104 is selected, the number of digits is determined (m:n?) (step S4); a (n+1) process is performed as a process for incrementing the input digit number n until m=n (step S5); and the display of the candidate symbols and the monitoring of the pressing down of the select buttons 101 to 104 are performed.

For the input password authentication process, it is determined whether the input password is correct or not, that is, whether the input password is identical to the registered password or not (step S6); if the input password is correct (Yes at step S6), it is notified that the input password is correct (step S7); if the input password is incorrect (No at step S6), it is notified that the input password is incorrect (step S8); and the password input/authentication process is completed. The notification of whether the input password is correct or incorrect may be displayed on the displaying unit 8 or may be displayed on other displaying units of the electronic apparatus.

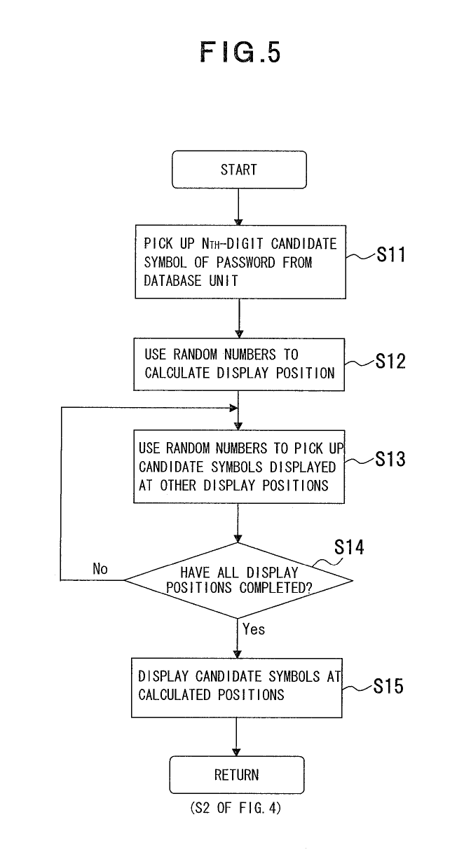

Description will be made of the display of the input candidate symbols on the displaying unit 8 with reference to FIG. 5. FIG. 5 is a flowchart of an example of a process procedure for the input candidates of a password.

This process procedure includes calculating the display positions of the password data with the use of random numbers and displaying the password data at all the display positions.

The specified nth-digit candidate symbol is picked up from the database unit 12 (step S11), and based on the execution of the password input/authentication program 16, any one of the display positions 81 to 84 is calculated with the use of the random numbers generated by the random-number generating unit 14 (step S12). If the display position 81 is calculated, the candidate symbols displayed at other display positions 82 to 84 are picked up from the database unit 12 using the random numbers (step S13); it is determined whether all the display positions 81 to 84 are completed or not (step S14); and the processes of steps S13 and S14 are performed until all the display positions 81 to 84 and the candidate symbols to be displayed are determined. When all the display positions 81 to 84 and the candidate symbols are selected (Yes at step S14), the candidate symbols are displayed at the calculated display positions 81 to 84 (step S15), and the procedure goes back to step S2 (FIG. 4).

In such a process, the candidate symbols of the password are displayed at arbitrary display positions 81 to 84 to perform the input preparation process for the password.

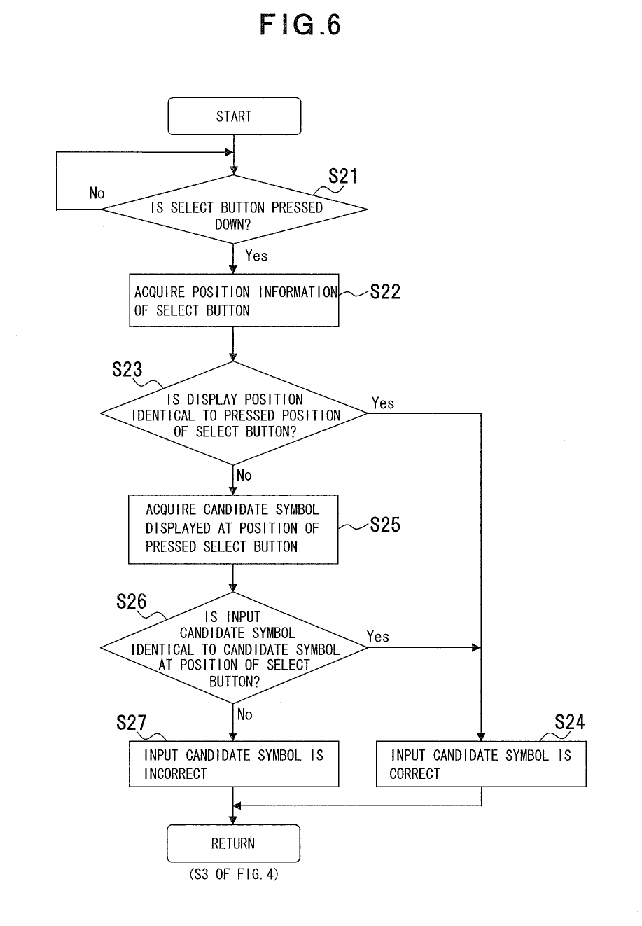

Description will be made of the monitoring process for the select buttons with reference to FIG. 6. FIG. 6 is a flowchart of an example of a process procedure for monitoring the select buttons.

This process procedure includes processes of pressing down the select buttons 101 to 104, acquiring the position information thereof, determining whether the input password is correct or incorrect, etc.

In the monitoring process for the select buttons 101 to 104, it is determined whether any one of the select buttons 101 to 104 is pressed down or not (step S21) and if any one of button is pressed down (Yes at step S21), the position information representing the pressed select button 101 to 104 is acquired (step S22). This position information is information that identifies the select buttons 101 to 104. Based on such acquisition of the position information, it is determined whether or not the display position 81 to 84 of the candidate symbol of the password is identical to the position of the pressed select button 101 to 104 (step S23), and since the display position 81 to 84 of the candidate symbol constituting the password is determined at step S12 of the flowchart shown in FIG. 5 and the display is performed at step S15 through step S12, if the positions are identical (Yes at step S23), it is determined that the input password data is correct, that is, the candidate symbol is correct (step S24).

If the display position 81 to 84 of the candidate symbol of the password is not identical to the operated position of the select button 101 to 104 (No at step S23), the password data displayed at the position of the pressed select button 101 to 104, i.e., the candidate symbol is acquired (step S25). It is determined whether or not the candidate symbol inputted by the pressed select button 101 to 104 is identical to the candidate symbol of the password (step S26), and if the symbols are identical (Yes at step S26), it is determined that the input candidate symbol is correct (step S24). If the candidate symbol inputted by pressing down any one of the select buttons 101 to 104 is not identical to the candidate symbol of the password (No at step S26), it is determined that the input candidate symbol is incorrect (step S27) and the procedure goes back to step S3 (FIG. 4).

In such a process, when the symbol string including the candidate symbol of the password is displayed at the display positions 81 to 84, the password can be inputted by pressing down the select button 101 to 104 at the position of the candidate symbol. Even when the same candidate symbols are displayed at two or more display positions 81 to 84, if any one of the corresponding select buttons 101 to 104 is pressed down, the candidate symbol can be inputted and the input password can be matched with the registered password.

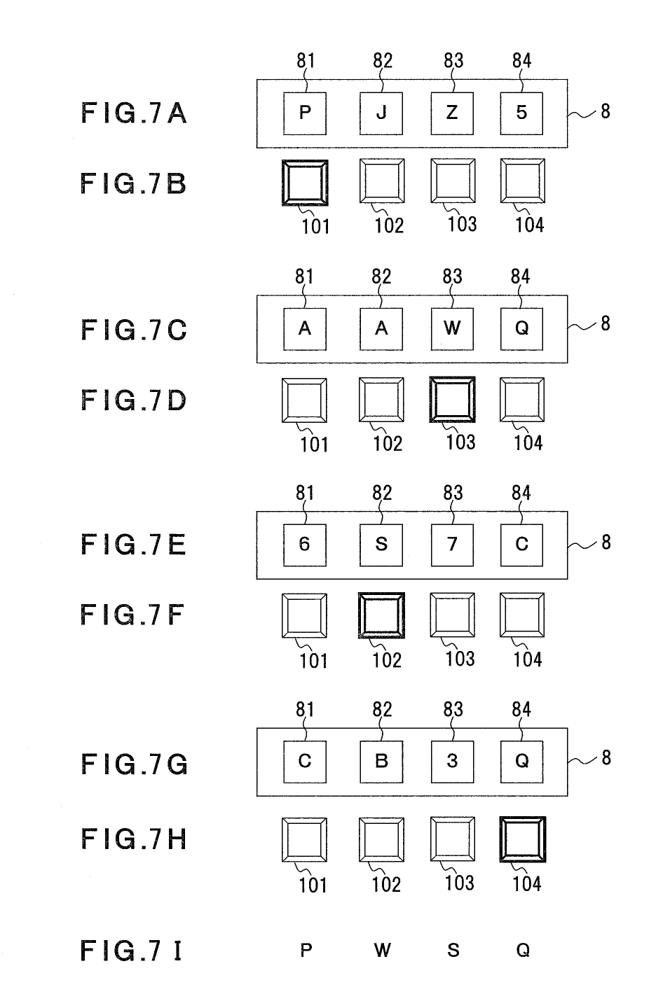

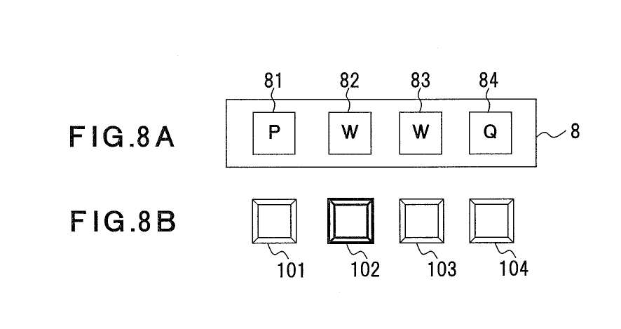

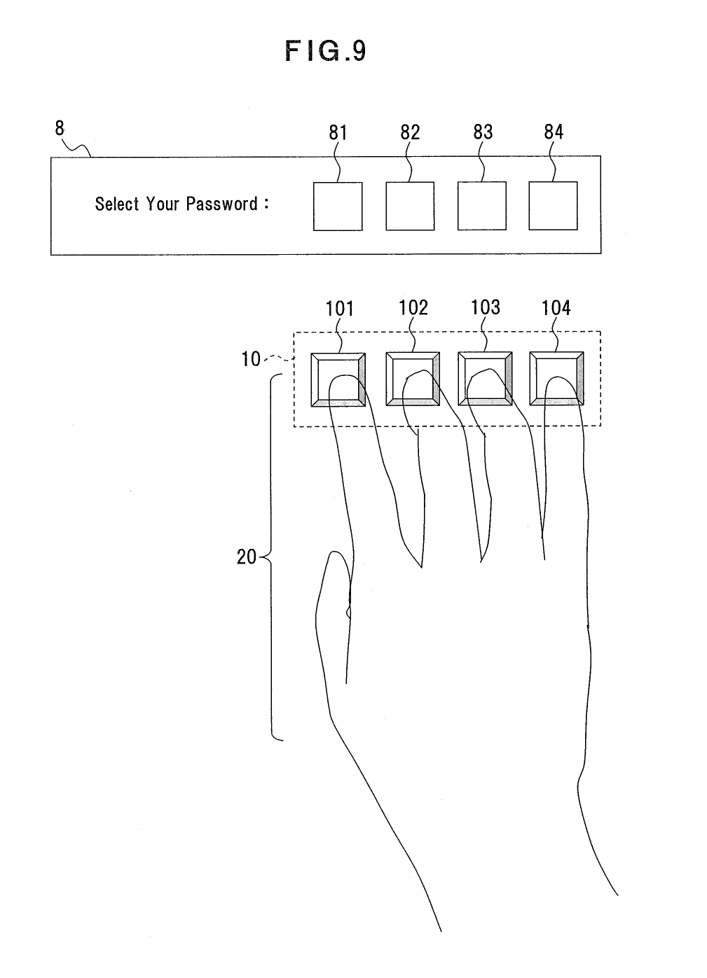

The input of the password will be described with reference to FIGS. 7A to 7I, FIGS. 8A and 8B, and FIG. 9. FIGS. 7A to 7I and FIGS. 8A and 8B show the display of the candidate symbols and the selection of the select buttons and FIG. 9 shows the operation of the select buttons. In FIGS. 7A to 9, the same numerals are added to the portions same as FIG. 2.

In this example, a password is assumed to be “PWSQ”. As shown in FIG. 7A, it is then assumed that a symbol string including the candidate symbol “P” is displayed at the display positions 81 to 84 of the displaying unit 8 by the position control using the random numbers. If a user presses down the select button 101 at the display position 81 of the password candidate symbol “P” in the symbol string as shown in FIG. 7B, the candidate symbol “P” is selected. After this selection, if a symbol string including the password candidate symbol “W” is displayed at the display positions 81 to 84 of the displaying unit 8 as shown in FIG. 7C and if the user presses down the select button 103 at the display position 83 of the password candidate symbol “W” in the displayed symbol string as shown in FIG. 7D, the candidate symbol “W” is selected. If a symbol string including the password candidate symbol “S” is then displayed at the display positions 81 to 84 of the displaying unit 8 as shown in FIG. 7E and if the user presses down the select button 102 at the display position 82 of the password candidate symbol “S” in the displayed symbol string as shown in FIG. 7F, the candidate symbol “S” is selected. If a symbol string including the password candidate symbol “G” is displayed at the display positions 81 to 84 of the displaying unit 8 as shown in FIG. 7G and if the user presses down the select button 104 at the display position 84 of the candidate symbol “Q” as shown in FIG. 7H, the candidate symbol “Q” is selected. In this way, the input of the password “PWSQ” is completed as shown in FIG. 7I.

The input password is compared with the registered password and if the input password is identical to the registered password, the input of the password is completed.

If the password candidate symbol “W” is displayed at a plurality of positions, for example, at the display positions 82, 83 of the display positions 81 to 84 of the displaying unit 8 as shown in FIG. 8A, any one of the select buttons 102, 103 corresponding to the display positions 82, 83 may be pressed down as shown in FIG. 8B, and in this case, the candidate symbol “W” at the display position 82 is inputted by pressing down the select button 102. The input process, the right/wrong decision, and the taking in of the input password are performed in steps S22 to S27 of FIG. 6.

In the process of the flowchart shown in FIG. 6, since the right/wrong decision is weighted by determining whether the input candidate symbol (input password data) is correct or incorrect and performing the right/wrong decision for the input password in the flowchart (FIG. 4) to which the procedure is returned, the credibility of the password input and the right/wrong decision can be enhanced.

As shown in FIG. 9, the operation can be performed easily by placing fingers 20 on the select buttons 101 to 104 set correspondingly to the display positions 81 to 84 of the displaying unit 8, and the password can be inputted quickly by the finger operation corresponding to the display positions 81 to 84.

As described above, according to this embodiment, since the password input can be achieved with less select buttons 101 to 104 and the display positions 81 to 84 and the candidate symbol data are displayed randomly, the password can be prevented from leaking out due to peeking, and since a few buttons are operated, the input operation is simple, which contributes to the reduction of the operation time and the speeding up of the input operation.

### Second Embodiment

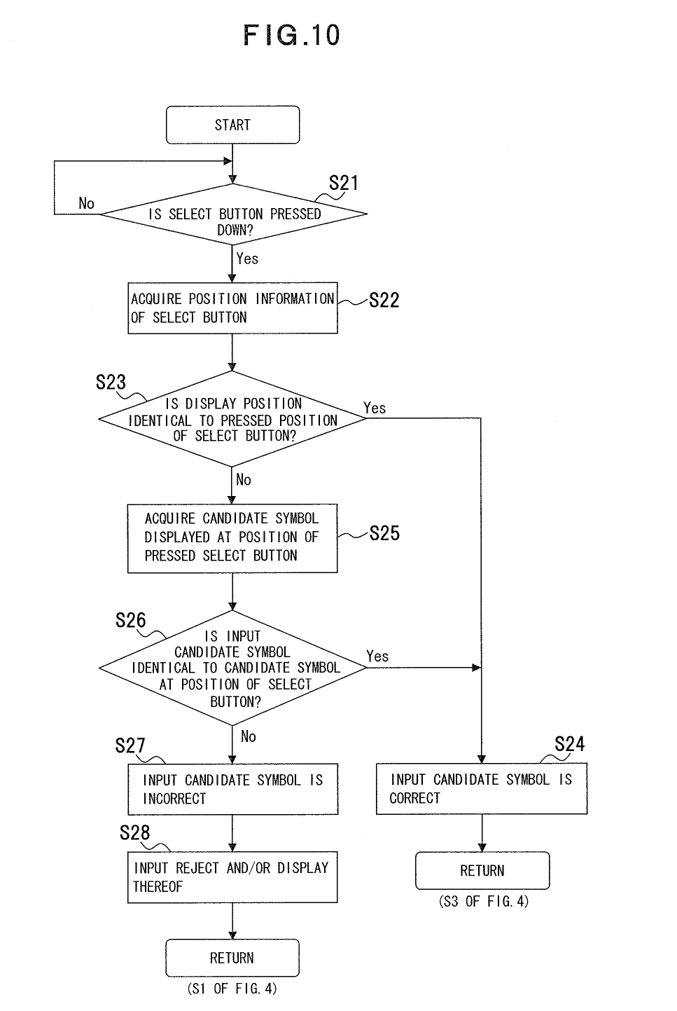

A second embodiment of the present invention will be described with reference to FIG. 10. FIG. 10 is a flowchart of another example of a process procedure for monitoring the select buttons. In FIG. 10, the same numerals are added to the portions same as the flowchart of FIG. 6.

In this embodiment, the password input/authentication system 2 (FIG. 1), the displaying unit 8 and the input unit 10 (FIG. 2), and the process procedure for the password input and authentication (FIG. 4) described above are also used.

The process procedure of this embodiment includes a process of input reject and/or display thereof if the input password data are incorrect, even in the middle of the input.

If the input password data are correct in the process of steps S21 to S26 (Yes at step S23, Yes at step S26, and step S24), the procedure is returned to step S3 of the flowchart of FIG. 4, and if a portion of the input password data is not identical, that is, if the candidate symbol is not identical in the middle of input (No at step S26), it is determined that the input password is incorrect (step S27), the password input is rejected and/or the input reject is displayed (step S28), and the procedure may be returned to step S1 of the flowchart of FIG. 4.

### Third Embodiment

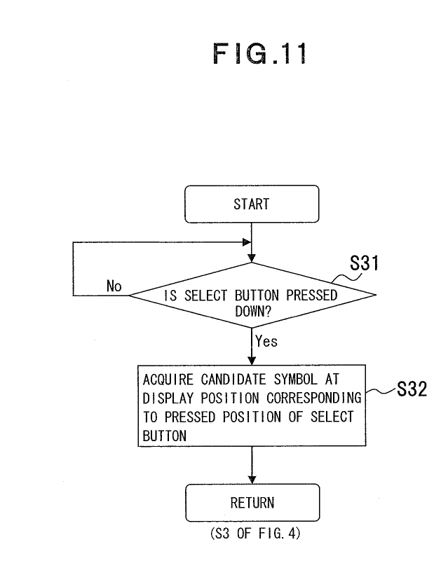

A third embodiment of the present invention will be described with reference to FIG. 11. FIG. 11 is a flowchart of another example of a process procedure for monitoring the select buttons.

In this embodiment, the password input/authentication system 2 (FIG. 1), the displaying unit 8 and the input unit 10 (FIG. 2), and the process procedure for the password input and authentication (FIG. 4) described above are also used.

The process procedure of this embodiment is the select button monitoring process that takes in only the selection input of the candidate symbols by the pressing down of the select buttons.

The pressing down of the select buttons 101 to 104 is monitored (step S31); the candidate symbol is acquired at the display position 81 to 84 corresponding to the operated position of the pressed select button 101 to 104 (step S32); and the procedure is returned to step S3 of the flowchart of FIG. 4.

In such a configuration, since the input password is compared with the registered password as well, no problem occurs in the password input and this contributes to the quick password input process.

### Other Embodiments

Other embodiments of the present invention are listed as follows.

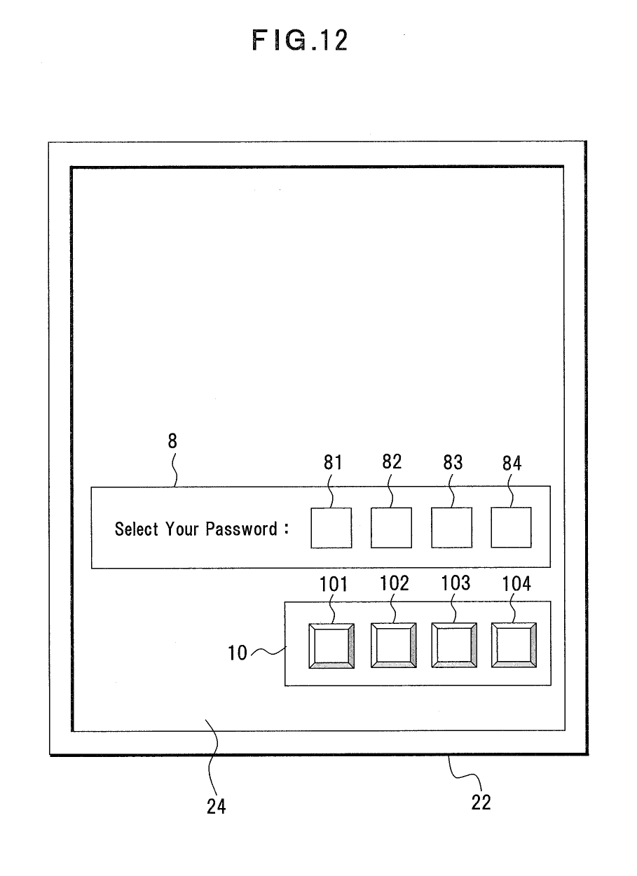

(1) Although description has been made of the configuration example using the sub-display for the displaying unit 8 by way of example in the above embodiments, the password input/authentication system may include a process or step that generates the displaying unit 8 and the input unit 10 as images on a display screen and, for example, as shown in FIG. 12, the displaying unit 8 and the input unit 10 may be displayed as images on a display screen 24 of a main display 22. In this case, the main display 22 is an image display device or a displaying unit of an electronic apparatus such as a personal computer and a cellular phone; the display positions 81 to 84 displaying the password candidate symbols are formed as images on the display screen 24 of the main display 22; the select buttons 101 to 104 are displayed as images at the positions corresponding to the display positions 81 to 84; the select buttons 101 to 104 are pressed down by key operations or cursor operations for the password candidate symbol displayed at the display position 81 to 84; and the candidate symbols are selected to input the password.

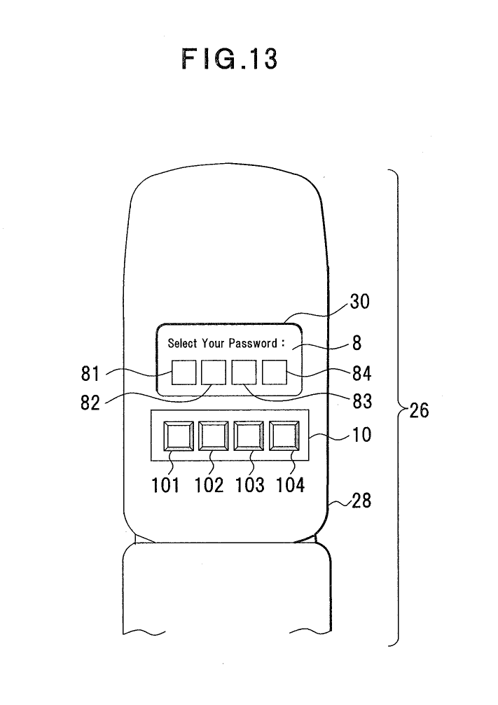

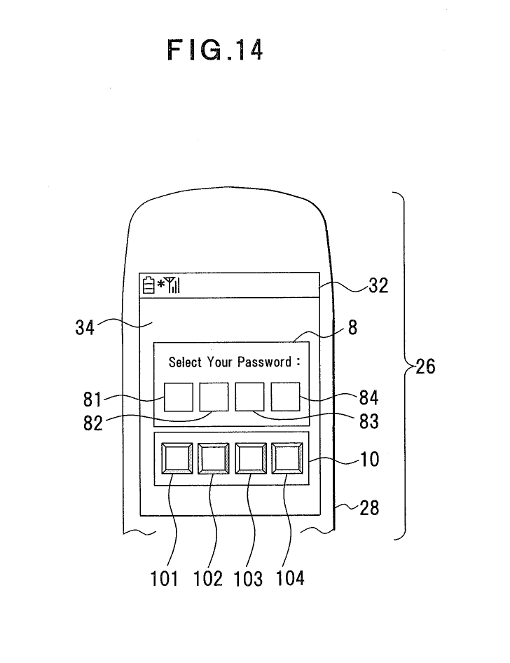

(2) The password input/authentication system 2 of the above embodiments can be used in various electronic apparatuses and can be used in a portable terminal device 26 as shown in FIG. 13, for example. In this case, the displaying unit 8 may be constituted by a sub-display 30 installed on a case 28 of the portable terminal device 26, and the select buttons 101 to 104 of the input unit 10 may be disposed correspondingly to the display positions 81 to 84 of the displaying unit 8, or as shown in FIG. 14, a display screen 34 of a main display 32 may display the display positions 81 to 84 of the displaying unit 8 and the select buttons 101 to 104 of the input unit 10 to input the password as in the case of (1) described above.

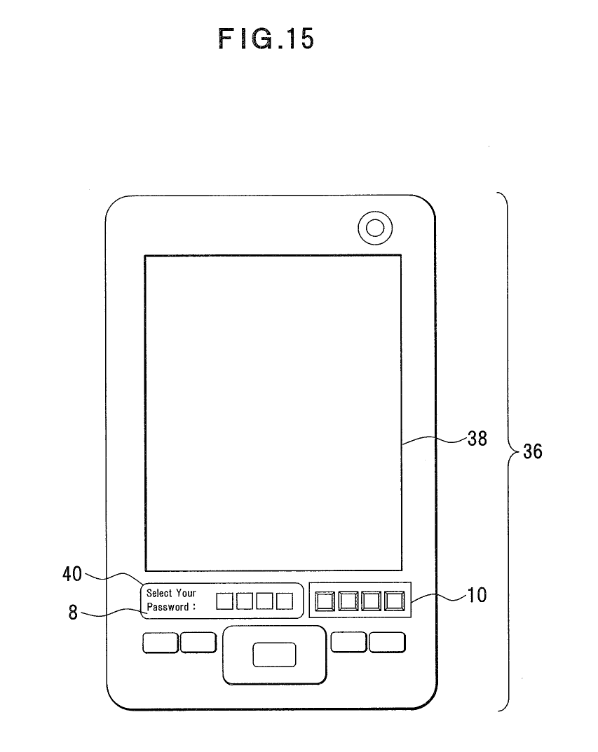

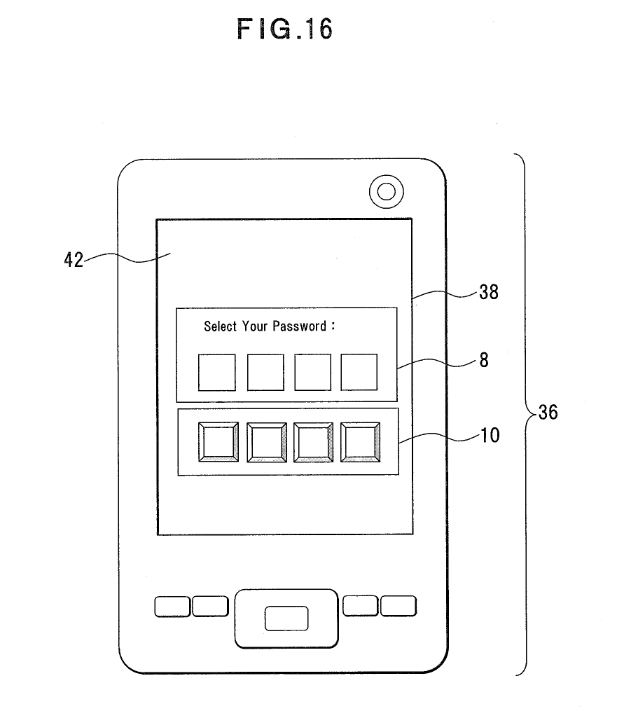

(3) The password input/authentication system 2 can be used in a personal digital assistant (PDA) 36 as shown in FIG. 15. In this case, a sub-display 40 may be formed adjacent to a main display 38 on the PDA 36 and this sub-display 40 may constitute the displaying unit 8, or as shown in FIG. 16, a display screen 42 of the main display may display the display positions 81 to 84 of the displaying unit 8 and the select buttons 101 to 104 of the input unit 10 to input the password as in the case of (1) described above.

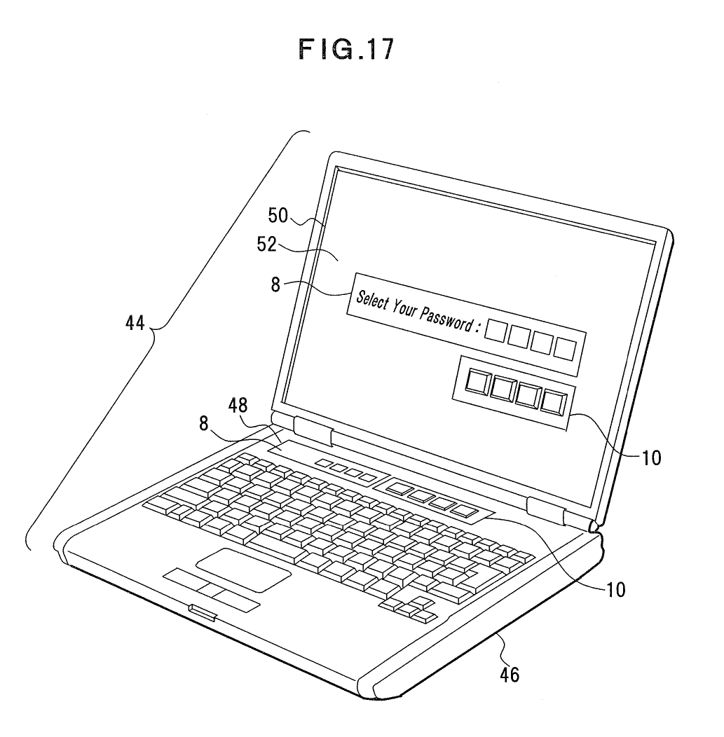

(4) The password input/authentication system 2 can be used in a personal computer (PC) 44 as shown in FIG. 17. In this case, the displaying unit 8 may be constituted by a sub-display 48 on a surface of a main body 46 of the PC 44, and the select buttons 101 to 104 of the input unit 10 may be set at the side of the displaying unit 8. A display screen 52 of a main display 50 of the PC 44 may display the display positions 81 to 84 of the displaying unit 8 and the select buttons 101 to 104 of the input unit 10 to input the password. In such a configuration, the password can be inputted from the input unit 10 of the main body 46 when turning on power, and the aforementioned password input and authentication can be used when an application program is launched after starting the operation.

(5) Although description has been made by illustrating a four-digit password in above embodiments, the present invention can be used for inputting a five or more digit pass word or a three or less digit password and is not limited by the digit number.

(6) Although the candidate symbol of the registered password is made appear and displayed when displaying the candidate symbols of the password in above embodiments, a candidate symbol string not included in the registered password may be displayed for a certain time and the displayed symbol string may be updated every time the certain time has elapsed to enable the input from the select button, and the present invention is not limited to including the registered candidate symbol of the password into the displayed symbol string.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

In various electronic devises, etc. using the password input, the present invention can contribute to simplification and acceleration of the password input and is useful.

What is claimed is:

1. A password input device comprising:
a displaying unit that includes a plurality of display positions displaying candidate symbols of a password;
a processing unit that displays the candidate symbols at the display positions; and
an input unit that allows the candidate symbols to be selected with select buttons corresponding to the display positions to input the password.

2. The password input device of claim 1, comprising:
a random-number generating unit that generates random numbers; and
a database that stores the candidate symbols of the password,
wherein the processing unit acquires the candidate symbols from the database and displays the candidate symbols at the display positions of the displaying unit, using the random numbers acquired from the random-number generating unit.

3. The password input device of claim 1,
wherein the displaying unit is constituted by a portion of a main display or a sub-display installed on an electronic apparatus.

4. The password input device of claim 1,
wherein the displaying unit is constituted by images on a display screen.

5. The password input device of claim 1,
wherein the select buttons are constituted by images on a display screen.

6. The password input device of claim 1,
wherein the candidate symbols include characters or graphics.

7. A password input method comprising the processes of:
generating candidate symbols of a password;
displaying the generated candidate symbols at a plurality of display positions; and
allowing the candidate symbols to be selected with select buttons corresponding to the display positions to input the password.

8. The password input method of claim 7, comprising the processes of:
generating random numbers; and
using the random numbers to acquire the candidate symbols of the password stored in a database.

9. The password input method of claim 7,
wherein the display positions are constituted by images on a display screen.

10. The password input method of claim 7,
wherein the select buttons are constituted by a keyboard or constituted by images on a display screen.

11. A computer readable recording medium having a password input program executable by a computer embodied therein, the password input program comprising the steps of:
generating candidate symbols of a password;
displaying the generated candidate symbols at a plurality of display positions; and
allowing the candidate symbols to be selected with select buttons corresponding to the display positions to input the password.

12. The computer readable recording medium of claim 11, the password input program comprising the steps of:
generating random numbers; and
using the random numbers to acquire the candidate symbols of the password stored in a database.

13. The computer readable recording medium of claim 11, the password input program comprising the step of generating the display positions on images on a display screen.

14. The computer readable recording medium of claim 11, the password input program comprising the step of taking in the candidate symbol at the display position by selecting the select button.

15. The computer readable recording medium of claim 11, the password input program comprising the step of generating the select buttons on images on a display screen.

16. An electronic apparatus that accept password input, comprising:
a displaying unit that includes a plurality of display positions displaying candidate symbols of a password;
a processing unit that displays the candidate symbols at the display positions; and
an input unit that allows the candidate symbols to be selected with select buttons corresponding to the display positions to input the password.

17. The electronic apparatus of claim 16, comprising:
a random-number generating unit that generates random numbers; and
a database that stores the candidate symbols of the password,
wherein the processing unit acquires the candidate symbols from the database and displays the candidate symbols at the display positions of the displaying unit, using the random numbers acquired from the random-number generating unit.

18. The electronic apparatus of claim 16,
wherein the displaying unit is constituted by a portion of a main display or a sub-display.

19. The electronic apparatus of claim 16,
wherein the displaying unit is constituted by images on a display screen.

20. The electronic apparatus of claim 16,
wherein the select buttons are constituted by images on a display screen.
